(19) United States
(12) Patent Application Publication
(10) Pub. No.: US 2012/0079239 A1
(43) Pub. Date: Mar. 29, 2012

(54) TIMING MODULE

(76) Inventors: Axel Aue, Korntal-Muenchingen (DE); Andreas Merker, Vaihingen/Enz (DE)

(21) Appl. No.: 13/213,773

(22) Filed: Aug. 19, 2011

(30) Foreign Application Priority Data
Sep. 2, 2010 (DE) 102010040130.7

(51) Int. Cl. G06F 15/78; G06F 9/02

(52) U.S. Cl. 712/36; 712/E09.002

(57) ABSTRACT

A timing module and a microcontroller. An independent processing unit, which is provided as a component of at least one closed-loop control circuit, is integrated in the timing module.

### FIELD OF THE INVENTION

The present invention relates to a timing module, i.e., a timer, which may be used in a microcontroller, as well as a microcontroller having such a timing module.

### BACKGROUND INFORMATION

Control modules that are used for executing various time-related functions are referred to as timing generators or timers. Timing modules or units normally include one or more different timing generators that may be operated independently of one another. Possible application areas include pulse generators, clock generators, units for measuring time and reference timers for event counters. In principle, timing generators may be implemented in the form of software or hardware.

German Patent Application No. DE 10 2007 044 803 describes a circuit arrangement, which has at least one timing module for providing a time base at a plurality of time control modules connected to it. The circuit arrangement is used for receiving signals and generating signals. In the timing module, one or more input signals are received and/or counted as a function of a clock pulse, and one or more output signals are generated as a function of them. In addition, a so-called time routing unit, which allows efficient signal analysis based on one or more time bases, is provided in the circuit arrangement.

Microcontrollers are used in many cases for controlling technical operations. To this end, it is necessary, in many cases, to regulate physical quantities. So-called closed-loop control circuits are used for this. A self-contained action sequence for influencing a physical quantity in a process is referred to as a closed-loop control circuit. In this connection, it is essential that the current value be fed back to the controller, and that setpoint and actual values are continuously compared.

Closed-loop control circuits that are used in conjunction with timing generators are well-known. In this context, use is made of the fact that known timing generators have building blocks such as PWM generators, which may be used in a closed-loop control circuit. Such timing generators are operated, for example, in conjunction with peripheral processors. For this, self-contained hardware modules are normally specially provided for closed-loop control circuits. Furthermore, it is known that the central processing unit (CPU) may be provided direct access to the timing generator for regulation. In this context, it should be taken into consideration that the CPU must access the timing generator comparison values rapidly, in particular, when results of an analog-to-digital conversion are intended to be incorporated into the timing generator structures.

In the case of closed-loop control circuits having timing generators, it should be considered that in known implementations, these closed-loop control circuits are associated with long latency times, since each channel is processed in succession and the CPU or peripheral processors access the timing generator via slow bus accesses (instances of bus access). When the results are released by an internal analog-to-digital converter, then the conversion time and the delay due to triggering of the analog-to-digital converter must be included, as well. Automatic controllers at which the CPU acts need even longer, for the main application is also run and some interrupts for other real-time functions lead to so-called worst-case delays.

### SUMMARY OF THE INVENTION

The timing module introduced may render short latency times possible, and therefore, automatic controllers may be presented that, until now, had to be set up in the peripherals in the form of hardware or could only be implemented using very fast microcontrollers. This may allow cost savings in the peripherals to be achieved, since no separate modules are necessary for the closed-loop control. In addition, no special modules are used in the microcontroller. The existing input, processing and output modules can satisfy the demands. The wording “independent processing unit” expresses that a processing unit, which is specially provided for the closed-loop control and is integrated in the timing module, is provided in the timing module, independent of the CPU of the microcontroller or of other external processors.

In this context, rapid closed-loop control may be achieved, using the described timing module that has an independent processing unit as a component. In this instance, the processing unit is integrated into a typically closed control loop. Further components of the timing module, such as PWM generators and one or, as the case may be, a plurality of input modules, are also included. The processing unit may have, in turn, a plurality of channels; this means that functions independent of one another and corresponding to the number of channels may be performed by the processing unit. Thus, it is possible to control several variables simultaneously.

### BRIEF DESCRIPTION OF THE DRAWING

FIG. 1 shows a specific embodiment of the microcontroller according to the present invention.

### DETAILED DESCRIPTION

The present invention is represented schematically in the drawing with the aid of a specific embodiment, and is described in detail below with reference to the drawing.

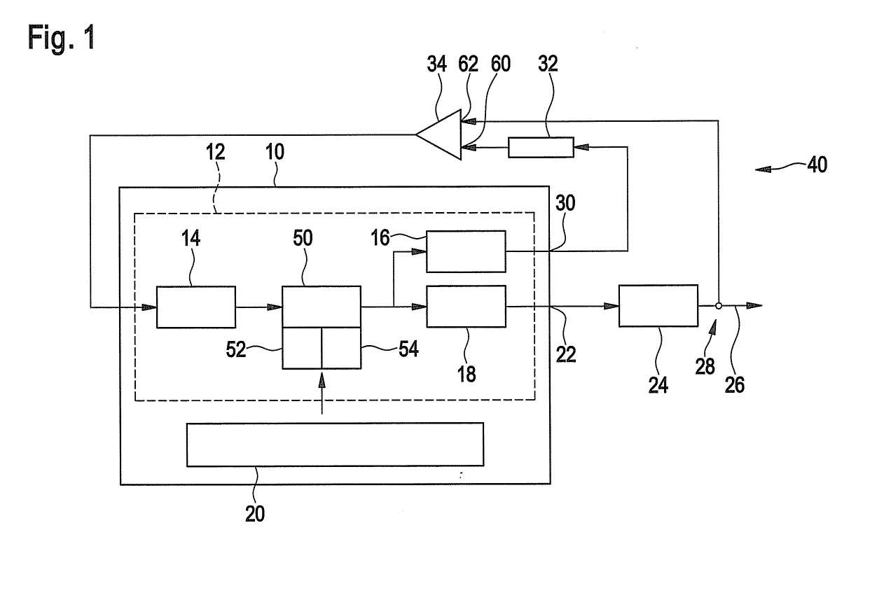

A variant of the described microcontroller, denoted, on the whole, by reference numeral 10, is represented in a block diagram in FIG. 1. This microcontroller has a timing module 12, which includes an input module 14, as well as a first PWM generator 16 and a second PWM generator 18. In addition, a central processing unit or CPU 20 is provided in microcontroller 10. Microcontroller 10 outputs a signal through output 22 to an actuator 24, for example, an output stage or a valve. Actuator 24 outputs, in turn, a controlled variable 26, normally a physical quantity such as current, voltage, temperature, etc., which is measured by a sensing device 28.

At a second output 30, a further signal is output to a D/A converter 32. In addition, a comparator 34 is provided whose output is connected to input module 14. In this manner, a closed control loop 40 is formed. Only one input module 14, which has, in this case, at least one digital filter, is shown in the representation of FIG. 1. Of course, a plurality of input modules 14 may also be provided.

Timing module 12 further includes a processing unit 50, which has a first RAM region 52 and a second RAM region 54. In principle, processing unit 50 may also have only one RAM region or more than two RAM regions. Processing unit 50 is integrated in timing module 12 and is a fundamental component of closed control loop 40. In the variant shown, it is, in this connection, an independent processing unit 50 in timing module 12 in microcontroller 10, the processing unit being able to operate independently of CPU 20.

Processing unit 50 is intended for various functions, such as the calculation of PWM values or the processing of input signals. In the variant shown, the processing unit has eight channels which may all execute functions independently of each other. Processing unit 50 may have one channel or a plurality of channels, depending on the requirement.

In the application, processing unit 50 controls first PWM generator 16, which applies a setpoint value to a first input 60 of comparator 34 via external D/A converter 32. In a possible variant, D/A converter 32 is an RC element having a resistor and a capacitor. Second PWM generator 18 controls actuator 24 with respect to controlled variable 26, such as current, voltage, temperature, speed of a motor, etc. The actual value is directed to a second input 62 of comparator 34 via the sensing device 28 or sensor. If the switching threshold of comparator 34 is reached, i.e., actual value >setpoint value, then the output signal of comparator 34 is directed to processing unit 50 via input module 14 of timing generator 12.

The digital filters present in input module 14 may be used to suppress interference signals or to define a minimum turn-on time and turn-off time. Processing unit 50, as an independent processor in timing module 12, then controls the closed-loop control and changes the actuating variable. The reference variable or the control parameters is or are stored in first RAM region 52. This is also true for the program of processing unit 50. If new parameters or a new reference variable is demanded by microcontroller 10, then CPU 20 writes the new data asynchronously into second RAM region 54. Processing unit 50 may then be synchronously switched over, using a trigger. Processing unit 50 then operates with the new data. This may take place during the run time. In this manner, external influences that are changing may also be reacted to in a suitable manner.

Short acting times may be achieved, since for the closed-loop control itself, it is not necessary for CPU 20 to take action, and therefore, the calculation and the control of the PWM output is not influenced by interrupts or slow access times. Furthermore, in processing unit 50, a trigger mechanism may be provided, by which it is possible to trigger a further channel of processing unit 50, when, for example, a particular controlled variable is reached. This further, i.e., second, channel may then start, e.g., a further automatic controller. This may also continue.

Furthermore, it is also feasible to parallelly direct signals, such as the reference variable at comparator 34, the actuating variable at actuator 24, the controlled variable or the output of comparator 34, from comparator 34 to a second channel of processing unit 50 via further input modules, and to monitor the signals. In the case of a fault, this channel may then block the actual control channel or set the PWM values to a safe level, in order to ensure a protected operation.

The processing unit 50 put forth, which may also be regarded as merely a circuit arrangement, is integrated in timing module 12 and is suitable for processing data for closed control loop 40. Parameters that determine the functioning of processing unit 50 may be configured at the run time. The processing unit 50 described may ensure that the closed-loop control is not disturbed, or even interrupted, by accessing actions by and on CPU 20, or by interrupts.

What is claimed is:

1. A timing module for a microcontroller comprising:
an independent processing unit integrated in the timing module, the processing unit being a component of at least one closed-loop control circuit.

2. The timing module according to 1, wherein the processing unit includes a plurality of channels, which all execute functions independently of one another.

3. The timing module according to 2, wherein one of the channels is for a trigger mechanism.

4. The timing module according to 2, wherein the processing unit is a component of a plurality of closed-loop control circuits.

5. The timing module according to 1, further comprising at least one input module that includes at least one digital filter.

6. The timing module according to 1, wherein the processing unit is set up in such a manner, that parameters that determine a method of functioning of the processing unit are configurable at run time.

7. The timing module according to 1, further comprising at least one PWM generator.

8. The timing module according to 1, wherein the processing unit includes at least one RAM region.

9. A microcontroller comprising:
a timing module; and
a central processing unit integrated in the timing module, the processing unit being a component of at least one closed-loop control circuit.

10. The microcontroller according to 9, wherein the microcontroller provides a signal for controlling an actuator.
